(19) United States
(12) Patent Application Publication
(10) Pub. No.: US 2026/0084229 A1
(43) Pub. Date: Mar. 26, 2026

(54) Broken Tap Extraction Tool with Tapered Sharp-Edged Teeth for Impact Driven Tap Removal

(71) Applicant: Full Boost Contracting Ltd., Dawson Creek (CA)

(72) Inventor: Ty Robert Ness, Dawson Creek (CA)

(21) Appl. No.: 19/336,885

(22) Filed: Sep. 23, 2025

Related U.S. Application Data
(60) Provisional application No. 63/699,476, filed on Sep. 26, 2024.

(51) Int. Cl. B23G 5/06; B25B 27/18

(52) U.S. Cl. CPC B23G 5/068; B25B 27/18

(57) ABSTRACT

A tap extraction tool for extracting a broken tap from a workpiece using an accompanying impact driver. The tool features a tool body shaft with a drive end, and a working end situated distally thereof along a longitudinal axis. The working end has tapered teeth and intervening void spaces arranged around the axis. The tapered tooth geometry includes a narrowing of a circumferential tooth width to a pointed biting edge in a radially inward direction, and a narrowing of a radial tooth thickness in the longitudinally distal direction. Two inner faces of the working tooth convergently intersect at the biting edge, which angles outwardly away from the central longitudinal axis in the longitudinally distal direction. The circumferential tooth width also narrows in a radially inward direction, from two non-parallel and convergently angled outside edges of an outer circumferential surface of the tooth.

### CROSS-REFERENCE TO RELATED APPLICATIONS

### This application claims benefit under 35 USC 119e of US Provisional Application No 63699476 filed September 26 2024 the entirety of which is incorporated herein by reference

### FIELD OF THE INVENTION

The present invention relates generally to tools, and more particular to tap extraction tools for extracting a broken tap from a workpiece.

### BACKGROUND

In the field of metal working, a known problem is the occasional breakage of taps that are used in the formation of threaded apertures in metal workpieces. In the event of such breakage, a portion of the broken tap is left lodged in the metal workpiece, and must be removed. Tools for such removal of a broken tap remnant from a metal workpiece are commonly referred to as tap extractors, and generally speaking, can be grouped into two types, which share in common the concept of a rotatable tool having a plurality of fingers thereon in a quantity equal to the number of the flutes possessed by the broken tap in question. The fingers are shaped for generally conforming fit into the flutes of the broken tap, whereby rotation of the tap extractor can be used to drive rotation of the broken tap in a retreating direction withdrawing it from the workpiece. The two main types of tap extractor are differentiated namely by the character of their fingers. A “fixed finger” type of tap extractor is one in which the extraction tool has a monolithic tool body of predefined and rigidly fixed shape, whereby the fingers reside at fixed orientations relative to one another. A “flex finger” type of tap extractor, the most well known of which may be those offered by the Walton Company of West Hartford Connecticut, is one of a multi-component construction, in which a group of separately embodied fingers are held together by a collar, relative to which the fingers can flex to a limited degree relative to a central longitudinal axis of the tool. Once the fingers are inserted int the flutes of the broken tap, the fingers are then tightenable into firmer abutment with the broken tap by displacement of a slidable sleeve toward the tips of the fingers, eventually bottoming out against the surface of the workpiece in which the broken tap is embedded.

A known problem in the art is a tendency for fingers of such tap extractors to bend or even snap during attempted extraction of stubbornly embedded tap remnants, based on which there is a need in the art for novel tools and methodology for extraction of broken taps that are less susceptible to possible breakage.

### SUMMARY OF THE INVENTION

According to a first aspect of the invention, there is provided a tap extraction tool for extracting a broken tap from a workpiece, said tap extraction tool comprising:

a tool body shaft having a drive end and a working end of opposing relationship to one another in a longitudinal directionality denoted by a central longitudinal axis of said shaft; and

a toothed shape profile possessed by said tool body shaft at the working end thereof, said toothed shape profile being characterized by a set of working teeth whose respective centers reside at respective locations around said longitudinal axis in a circumferential direction therearound with a respective empty void space left open between any adjacent pair of said working teeth, each of which has a tapered shape that is characterized by at least one of the following geometries:

(a) a narrowing of a circumferential width of the tooth to a pointed biting edge in a radially inward direction, in combination with a narrowing of a radial thickness of the tooth in a longitudinally distal direction moving away from the drive end of the tool body shaft, wherein said pointed biting edge resides at an intersection of two inner faces of the working tooth that are convergent to one another in said radially inward direction, and said biting edge angles outwardly away from the central longitudinal axis in said longitudinally distal direction; and/or

(b) a narrowing of a circumferential width of the tooth in both said longitudinally distal direction and said radially inward direction, said circumferential width being measured between two angled outside edges of an outer circumferential surface of the tooth, of which said two angled outside edges are non-parallel to the central longitudinal axis and convergent to one another in said longitudinally distal direction, from which angled outside edges the circumferential width of the working tooth tapers radially inwardly.

According to a second aspect of the invention, there is provided a method of removing a broken tap from a workpiece using the aforementioned tool recited in the first aspect of the invention. The inventive method comprises placing the working end of the tool over the broken tap, and driving combined axial and rotational movement of the working end of the tool, distally along and angularly around the central longitudinal axis thereof, respectively, with an impact driver, during which any included one of said biting edges and/or said angled outside edges at each of said working teeth frictionally engages the broken tap at an end of a respective flute thereof to aid in transfer of rotational energy from the tool to the broken tap in attempted unthreading thereof from the workpiece.

According to a third aspect of the invention, there is provided a tap extraction tool for extracting a broken tap from a workpiece, said tap extraction tool comprising:

a tool body shaft having a drive end and a working end of opposing relationship to one another in a longitudinal directionality denoted by a central longitudinal axis of said shaft; and

a toothed shape profile possessed by said tool body shaft at the working end thereof, said toothed shape profile being characterized by a set of working teeth whose respective centers reside at respective locations around said longitudinal axis in a circumferential direction therearound with a respective empty void space between any adjacent pair of said working teeth, each of which has a tapered shape characterized by one or more angled and pointed edges residing in non-parallel relationship to the central longitudinal axis and positioned and angled in a configuration operable to frictionally bite an end of a respective flute of the broken tap to aid in transfer of rotational energy from the tool to the broken tap in attempted unthreading thereof from the workpiece.

### BRIEF DESCRIPTION OF THE DRAWINGS

Preferred embodiments of the invention will now be described in conjunction with the accompanying drawings in which:

FIG. 1 is a perspective view of a novel tap extraction tool of the present invention.

FIG. 2 is an end view of the tap extraction tool of FIG. 1 from a drive end thereof.

FIG. 3 is a side view of the tap extraction tool of FIG. 1.

FIG. 4 is an annotated side view of the same tap extraction tool of FIG. 3, labelled with exemplary, but non-limiting, dimensions according to one preferred embodiment of the present invention.

FIG. 5 illustrates, in exploded view, an operating context of the tap extraction tool of FIG. 1, used in combination with a manual impact driver and hammer, by which the inventive tap extraction tool is actuated.

FIG. 6 illustrates the same operating context of FIG. 5, with the tap extraction tool in mated engagement by the impact driver, during striking thereof with the hammer, to axially and rotationally drive the tap extraction tool.

### DETAILED DESCRIPTION

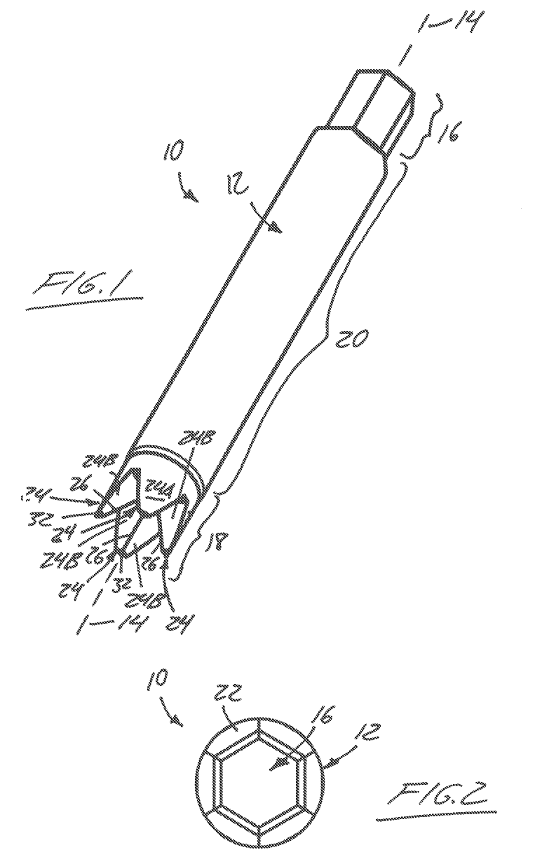

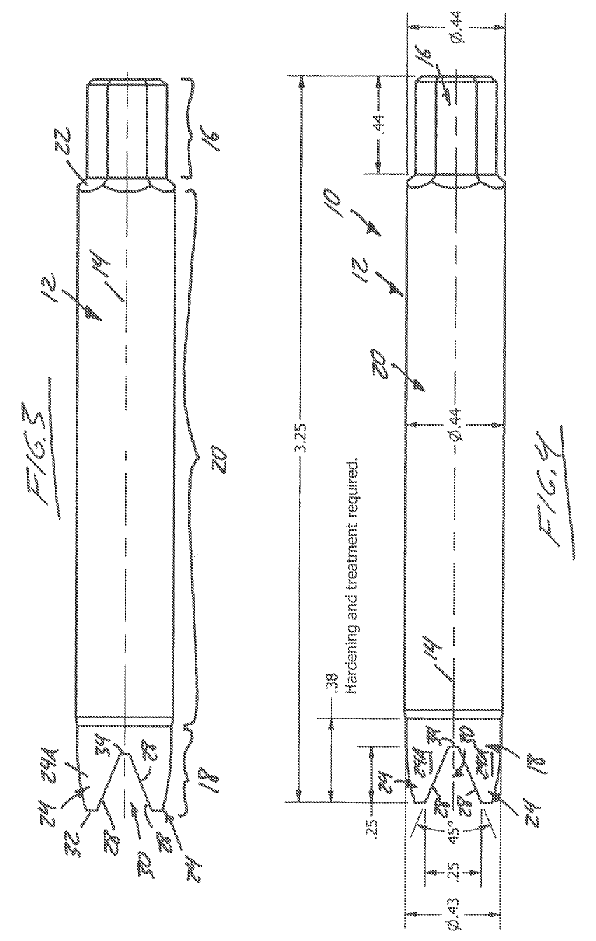

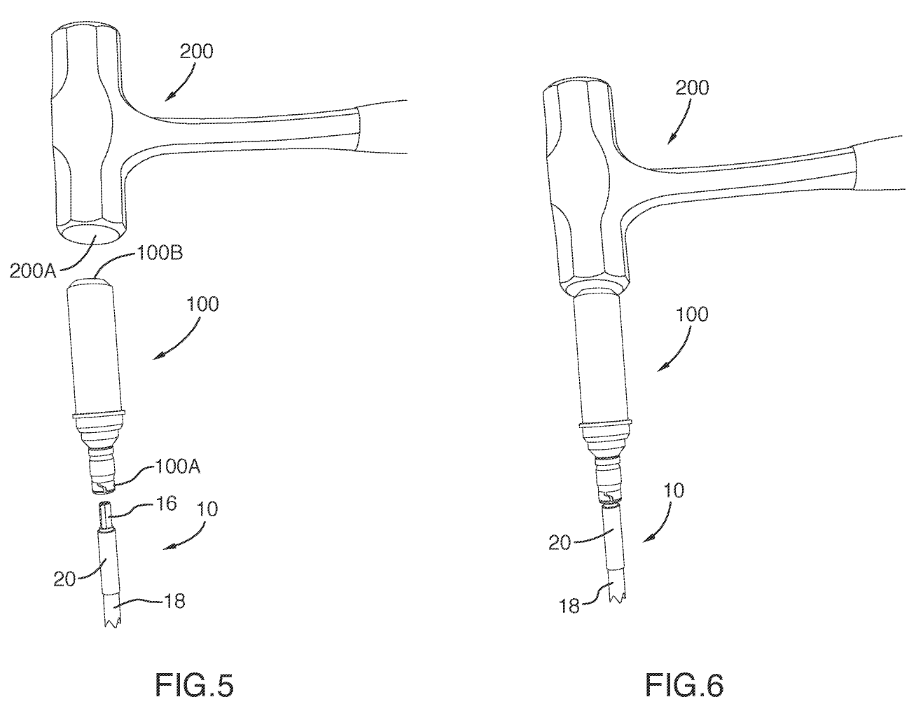

Referring initially to FIGS. 1 through 3, shown therein is a novel and inventive tap extraction tool 10 according to one preferred, but non-limiting, embodiment thereof. In the illustrated embodiment, the tool 10 has a monolith construction, and is composed solely of a unitary tool body 12 of metallic composition, typically a high strength steel alloy such as 4140 alloy steel, preferably hardened and heat treated. The tool body 12 is of elongated shaft-like character, being significantly greater in length, as measured in a longitudinal direction denoted by a central longitudinal axis 14, than it is in diameter, as measured in any radial direction perpendicular of the central longitudinal axis 14. The two longitudinally opposing ends of the tool body 10 are referred to herein as a driving end 16 and a working end 18, of which the driving end 16 refers to that from which the tool body 10 of the illustrated example is driven by a separate and independent impact driver, which may be of a conventional design, the details of which are thus not elaborated on herein in greater detail. In the working example shown in FIGS. 5 and 6, the tool 10 is used in cooperative combination with a manual impact driver 100, and an accompanying hammer 200, though in other scenarios, a powered impact driver may alternatively be used to drive the tool 10. The opposing working end 18 of the tool 10 refers to that at which it engages with a broken tap (not shown) that is to be extracted from a workpiece (not shown) in which the broken tap has become lodged.

In description of the tool 10, the term “end” is used herein in a broad sense, to encompass to a partial region of the tool body spanning a fractional length of the longitudinal direction up to an ultimate terminus of the tool, where as the term terminus is used in differentiating fashion to denote the ultimate extremity of the tool in a given direction. In relation to the longitudinal direction denoted by the central longitudinal axis 14, further directional reference is made possible herein by use of the terms proximal and distal. Of these, the term proximal denotes a longitudinal directionality moving toward the ultimate terminus of the tool at the driving end 16 thereof, and thus away from the opposing ultimate terminus tool at the opposing working end 18. The term distal denotes an opposing longitudinal directionality moving toward the ultimate terminus of the tool at the working end 18, and thus away from the ultimate terminus at the opposing driving end 16.

Situated longitudinally between the driving and working ends 16, 18 of the tool body 12 in the longitudinal direction is a mid-region 20 of the tool body 12, which in the illustrated embodiment is of externally cylindrical character, and possesses a uniform diameter throughout its axial length, as measured along the central longitudinal axis, though deviation from a uniform cylindrical shape of this mid-region may occur in other embodiments. The outer surface of the mid-region 20 may be knurled, at least over a fractional span of the mid-region’s axial length, typically over a proximal fraction thereof nearer to the driving end 16 of the tool body 12 than to the working end 18 thereof. The axial length of the mid-region of the tool body 12 exceeds the respective axial lengths the driving and working ends 16, 18 thereof, and also exceeds the combined lengths thereof in the illustrated example, for example measuring at least twice the combined lengths thereof, for example between two and four times thereof, and nearer to four times thereof than three times thereof in the illustrated example. That said, the proportionality of the axial lengths of the two ends 16, 18 and their intervening mid-region 20 may vary from these proportions in other embodiments.

The drive-end 16 is characterized by a driver-compatible shape profile in cross-sectional planes normal to the central longitudinal axis 14 in order to enable mated fitting with, and driven engagement by, an impact driver 100, which driver-compatible shape profile in the illustrated example is hexagonal, for example measuring 5/16-inch across its flats (5/16-inch AF), thus providing compatibility with a wealth of standard off-the-shelf impact drivers with sockets sized to accommodate a hexagonal male coupler of this size. A scalloped neck 22 provides smooth transition from the six faces of the hexagonally profiled driving end 16 to a slightly larger diameter of the cylindrical mid-region.

The most uniquely characterized portion of the tool body 12 is the working end 18 thereof, whose geometry differs notably from the flute-conforming finger geometry possessed by conventional tap extractors. The working end 18 of the tool body 12 has a toothed shape profile characterized by a set of axially protrusive working teeth 24 each having a relative sharp biting edge 26 on a radially inner side thereof that faces inwardly toward the central longitudinal axis, and a convergently angled pair of outside edges 28 at circumferentially opposing sides of the tooth 24. The illustrated example of the tool 10 is designed for use on a four-fluted tap, and thus has four such working teeth 24, one per flute of the tap. In other embodiments compatible with taps having a different quantity of flutes (e.g. a two-fluted tap or three-fluted tap), the quantity of working teeth 24 will vary in tap-matching fashion, to once again have a 1:1 ratio between the working teeth 24 of the tap extractor 10 and the flutes in the broken tap requiring extraction from the workpiece. The working teeth 24 are uniformly distributed at equal angular intervals circumferentially around the central longitudinal axis 14, thus having a ninety-degree center-to-center circumferential spacing from one tooth to the next in the illustrated four-tooth example, thus matching the typically uniform distribution of flutes at ninety-degrees to one another (center to center) around the central axis of a conventional four-fluted tap.

The four teeth are identically shaped, which shape is characterized by tapering of the tooth’s circumferential width (i.e. its width measured in arcuately circumferential relationship to the central longitudinal axis 14) in two different directions, namely a radially inward direction toward the central longitudinal axis 14, and a longitudinally distal direction toward the ultimate distal terminus of the tool body 12 at the working end 18 thereof. The tooth shape is further characterized by tapering of its radial thickness (i.e. its thickness measured radially of the central longitudinal axis) in the same longitudinally distal direction moving away from the drive end 16 of the shaft toward the ultimate distal terminus of the tool body 12. The radially inward taper of the circumferential width of each tooth ultimately terminates in the aforementioned biting edge 26. Each tooth 24 has a three-sided profile, composed of a convexly rounded outer circumferential surface 24A, and two flat inner surfaces 24B that are convergent to one another in the radially inward direction. These convergent inner surfaces 24B intersect at, and thus form the sharply pointed character of, the biting edge 26. In the illustrated example, the two flat inner surfaces of each tooth are of equal shape and surface area to one another, and intersect one another at a radial plane that is parallel to the central longitudinal axis 14 and oriented radially thereto. In the illustrated embodiment, the two flat inner surfaces 24B are therefore symmetric to one another across this radial plane occupied by the respective biting edge 26. Each biting edge 26 angles outwardly away from the central longitudinal axis 14 in the longitudinally distal direction, consistent with the aforementioned tapered character of the radial thickness of the tooth, which is measured between the biting edge 26 and the outer circumferential surface 24A of the tooth 24, and measured in the radial plane occupied by that biting edge 26.

Among the working teeth 24, each neighbouring pair thereof are physically separated from one another by a respective void space 30 left therebetween in the circumferential direction. Each void space 30 is tapered in a longitudinally proximal direction of longitudinally opposing directionality of the longitudinally distal direction in which the radial thickness and circumferential width of each tooth is tapered. The two outside edges 28 at circumferentially opposing sides of the outer circumferential surface 24A of each tooth 24 reside on opposite sides of the radial plane containing the tooth’s biting edge 26, and are convergent to one another in the distally longitudinal direction, in symmetric relation to one another across that radial plane. The teeth 24 and void spaces 30 are generally triangular, when viewed from outside in a direction of radial relation to the longitudinal axis 14. In the illustrated embodiment, the teeth are slightly truncated from a fully true triangular shape that would terminate in a sharp distal apex, and instead are actually trapezoidal, with each tooth 24 terminating in a narrow but flat distal tip 32 that lies parallel and coplanar with the flat distal tips of the other teeth 24 in a shared plane lying normally of the central longitudinal axis 14. Similarly, each void space 30 is near triangular, but actually trapezoidal, and bottoms out at a narrow but flat land 34 that interconnects the neighbouring outside edges 28 of the two neighbouring teeth 24, instead of bottoming out at a sharp vertex characterized by direct intersection of these neighbouring outside edges 28 of the two neighbouring teeth 24. This avoidance of sharp apexes at the distal tips of the teeth 24 and proximal extremities of the intervening void spaces 30 reduces the potential for tip breakage and stress cracks at such locations.

The tapered tooth geometry possessed by each of the identically shaped working teeth 24 is thus characterized by presence of the sharply pointed biting edge 26 at a radially innermost extremity of the tooth 24, and the presence of the two sharply pointed outside edges 28 at opposing circumferential extremities of the tooth where the outside circumferential surface 24A respectively intersects the two converging inner surfaces 24B, among which all of these sharply pointed edges 26, 28 are of non-parallel and obliquely angled relationship to the central longitudinal axis 14 of the tool 10. This set of three obliquely oriented sharp edges by which the tooth 24 operates to frictionally bite a terminal edge of a respective flute of the broken tap at a broken end of that flute.

FIGS. 5 and 6 illustrate use of the tool 10, which involves driven operation thereof by an impact driver 100, which in the illustrated example is a manual impact driver 100 relying on striking thereof with a separate handheld hammer 200 to power the combined axial and rotational stroke of the impact driver 100. The hexagonally profiled male drive end 16 of the tool 10 is engaged with the hexagonally socketed female output end 100A of the impact driver 100, from which a combined axial displacement and angular rotational action is impart to the tool 10 when the opposing input end 100B of the impact driver 100 is struck with the head 200A of the hammer 200. The impact driver 100 is thus operable to both displace the tool 10 axially along its central longitudinal axis 14, and simultaneously rotate the tool angularly around said central longitudinal axis 14. Before driving the tool in such fashion, the working teeth 24 of the tool’s working end 18 are inserted into respective flutes of the broken tap (not shown), during which the thread-cutting non-fluted portions of the tap are each wedged into a respective one of the tool’s void spaces 30 between two of the working teeth 24.

During this insertion of the teeth 24 into the flutes of the broken tap, the tool 10 eventually bottoms out through contact of the angled biting edge 26 of each tooth 24, and the two angled outside edges 28 thereof, with a terminal edge of the concave floor of the respective flute at the broken end thereof. The two angled outside edges 28 engage the edge of the flute floor at opposing sides of the flute floor, and the biting edge 26 situated midway between the two angled outside edges 28 engages the edge of the flute floor at a roughly midpoint location between the two opposing side terminuses of the flute floor. With the working teeth 24 of the tool 10 engaged with the flutes of the broken tap in such fashion, driving of the tool 10 by the impact driver 100 applies axial force to the drive end 16 of the tool in a manner imparting added axial bite force at the edgewise engagement of each working tooth 24 to the floor edge of the respective flute of the broken tap, while simultaneously driving angular rotation of the tool 10 about its central longitudinal axis 14, thus imparting rotational torque to the broken tap to rotate it in a retreating direction drawing it out from the workpiece in which it is lodged. Prototyping and testing of the tool 10 has demonstrated its effectiveness at broken tap extraction, with greater durability against tool breakage compared to the damage-susceptible fingers of conventional tap extractors.

Since various modifications can be made in the invention as herein above described, and many apparently widely different embodiments of same made, it is intended that all matter contained in the accompanying specification shall be interpreted as illustrative only and not in a limiting sense.

1. A tap extraction tool for extracting a broken tap from a workpiece, said tap extraction tool comprising:
a tool body shaft having a drive end and a working end of opposing relationship to one another in a longitudinal directionality denoted by a central longitudinal axis of said shaft; and
a toothed shape profile possessed by said tool body shaft at the working end thereof, said toothed shape profile being characterized by a set of working teeth whose respective centers reside at respective locations around said longitudinal axis in a circumferential direction therearound with a respective empty void space left open between any adjacent pair of said working teeth, each of which has a tapered shape that is characterized by at least one of the following geometries:
(a) a narrowing of a circumferential width of the tooth to a pointed biting edge in a radially inward direction, in combination with a narrowing of a radial thickness in a longitudinally distal direction moving away from the drive end of the tool body shaft, wherein said pointed biting edge resides at an intersection of two inner faces of the working tooth that are convergent to one another in said radially inward direction, and said biting edge angles outwardly away from the central longitudinal axis in said longitudinally distal direction; and/or
(b) a narrowing of a circumferential width of the tooth in both said longitudinally distal direction and said radially inward direction, said circumferential width being measured between two angled outside edges of an outer circumferential surface of the tooth which are non-parallel to the central longitudinal axis and convergent to one another in said longitudinally distal direction, from which angled outside edges the circumferential width of the working tooth tapers radially inwardly.

2. The tool of claim 1 characterized by at least geometry (a), and thus comprising said biting edges by which each tooth is configured to frictionally bite a floor edge of a respective flute of said broken tap at an intermediate point between opposing side extremities of said flute.

3. The tool of claim 1 characterized by at least geometry (b), and thus comprising said angled outside edges at each working tooth, by which said each working tooth is configured to frictionally bite a floor edge of a respective flute of said broken top near opposing side extremities of said flute.

4. The tool of claim 1 characterized by both geometry (a) and geometry (b), and thus comprising said biting edges, by which each working tooth is configured to frictionally bite a floor edge of a respective flute of said broken tap at an intermediate point between opposing side extremities of said flute, and said angled outside edges, by which said each working tooth is configured to frictionally bite the floor edge of the respective flute near said opposing side extremities thereof.

5. The tool of claim 2 wherein the biting edge of each tooth lies in a radial plane of parallel relationship to the central longitudinal axis.

6. The tool of claim 2 wherein the two inner surfaces of each tooth are symmetrical to one another across a reference plane in which the biting edge of the tooth resides.

7. The tool of claim 1 wherein each working tooth distally terminates at a non-pointed distal tip.

8. The tool of claim 7 wherein the non-pointed distal tips of the working teeth are flat and coplanar with one another in a shared plane lying normally of the central longitudinal axis.

9. The tool of claim 1 wherein a proximal extreme of each empty void space between said any adjacent pair of the working teeth is a non-pointed land.

10. The tool of claim 1 wherein the locations at which the respective centers of the teeth reside are uniformly distributed around the central longitudinal axis.

11. The tool of claim 1 wherein the working end of the tool consists solely of said working teeth.

12. The tool of claim 1 wherein a distal terminus of the tool at the working end thereof, situated longitudinally furthest from a proximal terminus of the tool at the driving end thereof, consists solely of distal tips of the working teeth.

13. The tool of claim 1 comprising a driver-compatible shape profile possessed by said shaft at the drive end thereof and configured for driven engagement of said drive end of the shaft by a separate impact driver.

14. The tool of any claim 13 in combination with said impact driver.

15. A method of removing a broken tap from a workpiece using the tool of claim 1, comprising placing the working end of the tool over the broken tap, and driving combined axial and rotational movement of the working end of the tool, distally along and angularly around the central longitudinal axis thereof, respectively, with an impact driver, during which any included one of said biting edges and/or said angled outside edges at each of said working teeth frictionally engages the broken tap at an end of a respective flute thereof to aid in transfer of rotational energy from the tool to the broken tap in attempted unthreading thereof from the workpiece.

16. A tap extraction tool for extracting a broken tap from a workpiece, said tap extraction tool comprising:
a tool body shaft having a drive end and a working end of opposing relationship to one another in a longitudinal directionality denoted by a central longitudinal axis of said shaft; and
a toothed shape profile possessed by said tool body shaft at the working end thereof, said toothed shape profile being characterized by a set of working teeth whose respective centers reside at respective locations around said longitudinal axis in a circumferential direction therearound with a respective empty void space between any adjacent pair of said working teeth, each of which has a tapered shape characterized by one or more angled and pointed edges residing in non-parallel relationship to the central longitudinal axis and positioned and angled in a configuration operable to frictionally bite an end of a respective flute of the broken tap to aid in transfer of rotational energy from the tool to the broken tap in attempted unthreading thereof from the workpiece.

17. The tool of claim 16 wherein said one or more angled edges comprises a biting edge residing at a radially inner extremity of the working tooth, and oriented to angle away from the central longitudinal axis in a longitudinally distal direction away from the drive end of the tool body shaft.

18. The tool of claim 16 wherein said one or more angled edges comprises at least one angled outside edge of the working tooth at a circumferential extremity thereof, which angled outside edge angles away from a neighbouring working tooth situated across the respective empty void space from said angled outside edge.

19. The tool of claim 18 wherein said at least one angled outside edge of the working tooth comprises two angled outside edges thereof at two respective circumferential extremities thereof, said two angled outside edges being of convergent relationship to one another toward a distal terminus of the working tooth residing furthest from the drive end of the tool body shaft.

20. A method of removing a broken tap from a workpiece using the tool of claim 16, comprising placing the working end of the tool over the broken tap, and driving combined axial and rotational movement of the working end of the tool, distally along and angularly around the central longitudinal axis thereof, respectively, with an impact driver, during which said one or more angled and pointed edges at each of said working teeth frictionally engage the broken tap at an end of a respective flute thereof to aid in transfer of rotational energy from the tool to the broken tap in attempted unthreading thereof from the workpiece.
